(19) United States
(12) Patent Application Publication
(10) Pub. No.: US 2004/0119304 A1
(43) Pub. Date: Jun. 24, 2004

(54) Dog feces collecting device

(76) Inventors: Shintaro Iso, Saitama (JP); Akiko Iso, Saitama (JP)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 10/457,865

(22) Filed: Jun. 9, 2003

(30) Foreign Application Priority Data
Dec. 19, 2002 (JP) 2002-383380

(51) Int. Cl. A01K 29/00; E01H 1/12

(52) U.S. Cl. 294/1.3

(57) ABSTRACT

A dog feces collecting device has a main unit divided into a feces collection chamber and a toilet paper holding chamber, and a scoop provided on a front part of the collection chamber which is pivotable between a closed position in which it closes off the front part of the collection chamber and an open position in which it projects outwardly from the front part of the collection chamber as a feces receiving surface. The toilet paper is advanced around and onto the feces receiving surface of the scoop so that the feces of the dog may be deposited on the toilet paper and wrapped therein and held in the collection chamber for disposal in a hygienic manner. The scoop may be formed with a front wall at a ninety degree angle to a back wall and side walls for preventing waste matter from dropping off the sides, and with knobs projecting from the sides for opening and closing the scoop. A paper advancing mechanism including a knob and paper feed roller is used for advancing a leading edge of the toilet paper out through a slot in the bottom of the toilet paper holding chamber and along a paper path running along the bottom of the main unit to the scoop at the front part of the collection chamber.

### TECHNICAL FIELD

This invention generally relates to a dog feces collecting device, and more particularly, to one which has a dispenser for paper to hygienically dispose of collected dog feces.

### BACKGROUND OF INVENTION

The prior art includes a “box type” of dog feces collecting device shown in the closed position in FIG. 7A and in the opened position in FIG. 7B. The box container has half sections 70a, 70b which are split along dividing line 70 and which are hinged together at the top and pivoted to the open position (in the directions of the arrows) by handle levers 72. The opening formed in the bottom surface is about 5˜8 cm wide and can be placed over the feces on the ground to scoop the feces up. This type of device has the problem that when a large dog discharges an entire load on the ground, the pile may be too large to be covered by the relatively narrow width of the box opening. Also, since the box sections are placed over the feces pile, the feces may be covered from view by the upper part, which makes it difficult to confirm visually the presence of the feces in order to pick up the feces.

Another problem is that the feces can become spread out so that perhaps only part of the entire load can fit within the box opening while a part of the feces will in the end adhere to the outside walls of the device. Moreover, because this design type opens from the bottom surface, it is thus not possible to receive the feces before the dog discharges by placing it directly below the anus as the dog is squatting. Therefore, while these devices are suitable for small dogs and dogs of a medium size, they are not compatible with large dogs. In addition, if feces should become adhered to the main unit, the design does not provide a way for hygienic disposal, such as by containing it with toilet paper needed to remove the contamination, and one thus has to take along tissue paper or the like to take a dog for a walk, etc. In addition, since most other types of collecting wraps, such as tissue papers or, plastic film, are not soluble in water, the waste cannot be flushed with water into a toilet and instead, must be discarded as is into a nearby garbage can, thereby creating a problem from the viewpoint of hygiene and bad odors in public places.

Discarding of the feces of dogs is not only prohibited by land owners, road maintenance, and other health administrative rules, it is also a major nuisance for commuters, and even when administrative agencies attempt to solve this problem by erecting signs and posting warnings on posters, the fact is that the present situation with respect to public discarding of feces remains an annoying problem with no remedy for improvement in sight.

Walking a dog is thus often frustrating when one has to carry a scoop or a vinyl bag and manipulate it by hand and risk contamination for this purpose. It is therefore a principal object of the present invention to greatly reduce the inconvenience connected with troublesome handling of the feces of dogs maintained in households and at the same time to improve environmental hygiene. A particular object of the invention is to make it possible to collect feces without contamination of hands or clothing, and to employ toilet paper in the device in such a way as to enable the feces to be handled and disposed of without contaminating the main unit. It is also an object to keep the feces concealed in the device so that it can be carried without being visible or touched. The overall purpose of this invention is to provide for clean and convenient disposal of dog feces while promoting improved hygiene in our environment as an important requirement of our society.

### SUMMARY OF INVENTION

In accordance with the present invention, a dog feces collecting device has a main unit divided into a feces collection chamber and a toilet paper holding chamber, and a scoop provided on a front part of the collection chamber which is pivotable between a closed position in which it closes off the front part of the collection chamber and an open position in which it projects outwardly from the front part of the collection chamber as a feces receiving surface for the device, wherein toilet paper held in the toilet paper holding chamber is advanced around and onto the feces receiving surface of the scoop so that the feces of the dog may be deposited on the toilet paper and wrapped therein and held in the collection chamber for disposal in a hygienic manner.

In a preferred embodiment, the scoop is formed with a front wall at a ninety degree angle to a back wall and side walls for preventing waste matter from dropping off the sides. The scoop is provided with a knob on one or both sides of the front wall projecting from the sides of the main unit for opening and closing the scoop. The toilet paper holding chamber is provided with a core holder for holding a roll of toilet paper thereon, and a spring plate for adjustably holding different diameter cores of toilet paper rolls. A paper advancing mechanism including a knob and paper feed roller is used for advancing a leading edge of the toilet paper out through a slot in the toilet paper holding chamber and onto the feces receiving surface of the scoop in the open position, by rotation of the operating knob. The leading edge of the toilet paper is advanced through a slot in the bottom of the toilet paper holding chamber and along a paper path running along the bottom of the main unit to the scoop at the front part of the collection chamber. The scoop can have a binder clip provided on its front surface for holding the leading edge of the toilet paper for the next usage. The toilet paper holding chamber has a side access door for allowing access therein to install or change the roll of toilet paper, and the door may have a transparent window for confirming the remaining amount of toilet paper in the device. The main unit may have a handle on its upper part which can be moved to the left or right to adjust the upright position of the device during use. The main unit is made primarily of plastic material for a light weight design, and the scoop is made of metal for durability.

Other objects, features, and advantages of the present invention will be explained in the following detailed description of the invention having reference to the appended drawings.

### BRIEF DESCRIPTION OF DRAWINGS

FIG. 1A is a front view of the dog feces collecting device in accordance with the present invention.

FIG. 1B is a rear view of the device.

FIG. 2A is a left side schematic view of the device, and FIG. 2B is a right side schematic view of the device.

FIG. 3 is a plan view particularly illustrating the toilet paper path and compartment of the device.

FIG. 4 is a perspective view particularly illustrating the use of the scoop to collect dog feces contained within toilet paper and receive it in the holding compartment of the device.

FIG. 5A is a front schematic view and FIG. 5B is a side schematic view of the scoop portion of the device.

FIG. 6 is a side schematic view of the toilet paper roll holder of the device.

FIGS. 7A and 7B are front schematic views (in closed and open positions) of a prior art “box-type” dog feces collecting device.

### DETAILED DESCRIPTION OF INVENTION

This invention is directed to a dog feces collecting device for enabling a pet owner or caretaker to collect the feces of dogs (small to large), by opening a scoop door and placing it directly below the anus of the dog as it prepares to discharge, then disposing of the feces in a hygienic manner without touching directly by hand the feces of the dog, or having to scoop up feces that might otherwise fall to the ground. In addition, the invention also makes it possible to conceal scooped up feces in a containment chamber by closing the scoop and to carry them so that they are not visible to human view. The invention is also provided with a containment chamber that has a dispenser for toilet paper to maintain cleanliness in the scoop part and in the main unit, and so that the feces can be discarded wrapped in the paper, including by flushing into a toilet.

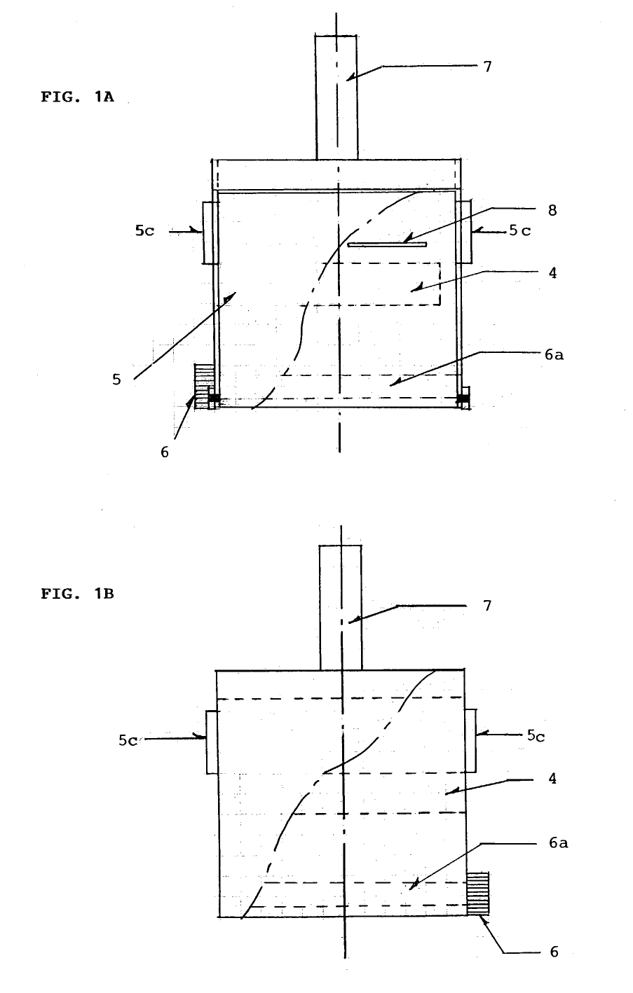

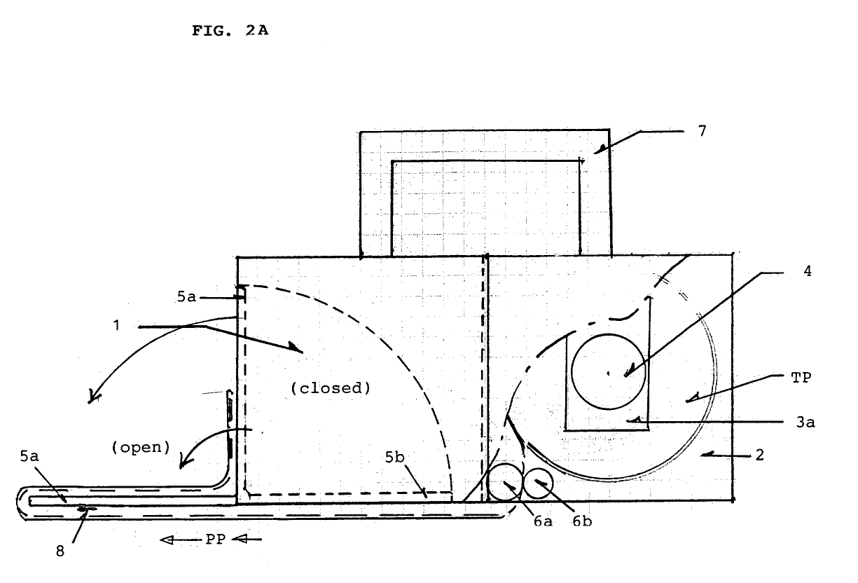

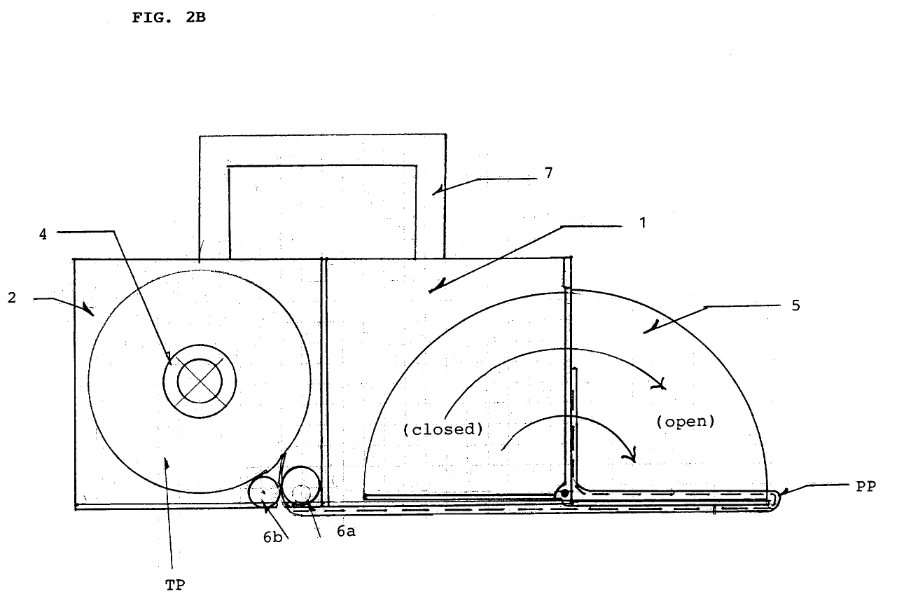

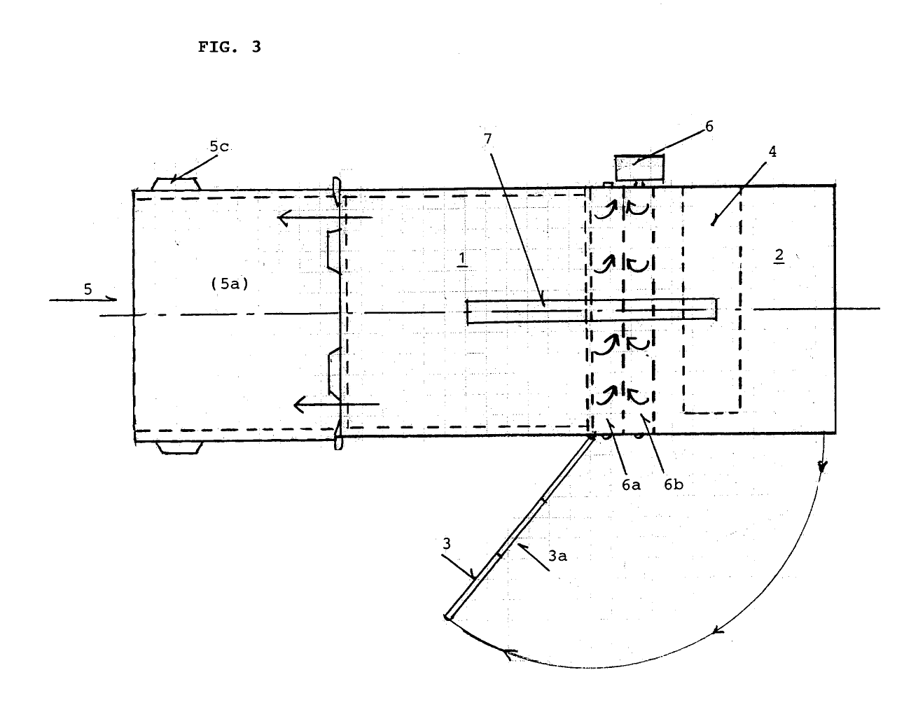

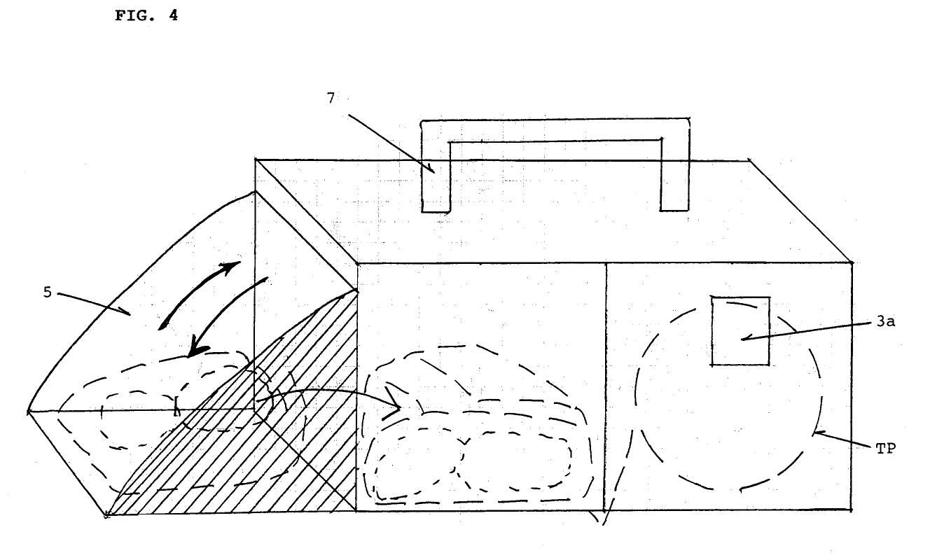

Referring to FIGS. 1A, 1B, 2, and 3, a preferred embodiment of the dog feces collecting device has a feces containment chamber 1, a paper chamber 2 for housing a roll of toilet paper, a door 3 for access to the paper chamber 2, a toilet paper core holder 4 in the paper chamber 2, a scoop 5 of the pivoted opening and closing type having a front wall 5a and back wall 5b and knobs 5c for operating the scoop for opening and closing, a knob 6 and advancing roller 6a for adjustment of the amount of feeding the toilet paper, a main unit handle 7, and a binder clip 8 for convenient holding of the leading edge of the toilet paper in a fixed position (on the front of the scoop).

The main unit of the device is divided into the two compartments comprising the containment chamber 1 which can be opened and closed by the scoop 5 at the leading edge of the chamber, and the toilet paper containment chamber 2. The scoop 5 can be fabricated by metallic processing to have a right-angle shape which, when pivoted to the open position, can receive the feces of the dog therein, and when pivoted to the closed position, can hold the feces (wrapped in toilet paper) within the containment chamber 1 hidden from view.

The toilet paper containment chamber 2 is designed to hold a roll of toilet paper TP within the chamber on the toilet paper holder roller 4. A window 3a may be provided in the door 3 to the chamber 2 to provide a visual indication of the remaining amount of toilet paper TP on the roll. The leading edge of the toilet paper TP is threaded between the paper feed roller 6a and an associated clamp roller 6b and fed (by advancing the paper feed knob 6) out through a slot in the bottom wall of the paper chamber 2 and along a paper path PP at the bottom of the main unit. When the unit is being used to collect the feces of a dog, the leading edge of the paper TP is advanced around and over the edge of the front wall 5a of the scoop 5 to cover the top surface of the front wall 5a as well as part of the back wall 5b of the scoop. In this manner, when the top surface of the front wall 5a is placed under the anus of the dog, the feces can be received on top of the toilet paper TP and covered by the leading edge lying against the back wall 5b, as well as covered from the other side by the extra length of paper separated from the paper long the paper path PP. With the feces wrapped and covered from both sides in the toilet paper TP, the scoop can be pivoted by knobs 5c back to the closed position where it is contained inside the containment chamber. For convenience, the next length of toilet paper TP can be advanced by knob 6 and roller 6a to provide sufficient length to allow its leading edge to be clipped or pinned under the binder clip 8 for the next usage.

The opening and closing of the scoop 5 is operated by the knobs 5c attached to the front face 5a of the scoop and projecting by a small amount from the side face of the main unit. The scoop also has side walls 5d which form a containment area along with the front face 5a and back face 5b for preventing waste matter from dropping off the sides. To open the scoop, the user pushes the knob 5c down until the front face 5a of the scoop is in the horizontal position to be placed under the anus of the dog. The back wall 5b of the scoop is then in the vertical position closing off the front end of the main unit. The scoop rotates through an angle from 0° to 90°. It may be mounted to the main unit by pivot pins inserted into pivot holes 5f on each side of the scoop. A stopper 5e is provided at the top for abutting a stopper plate at the top of the front wall of the main unit when the scoop is pivoted to the open position.

Metal working of the scoop may be required in order to provide a material more durable than a plastic tip. In addition, it is possible to make the opening and closing of the scoop in fixed stages, since any fixed angle can be set, so that the design is thus adaptable to the size of the dog and rear end. And while it is also conceivable that the function enabling to receive feces does not necessarily require toilet paper equipment, this is useful as it resolves the problems of having to carry around paper for wiping off contamination, and it also provides for hygienic handling.

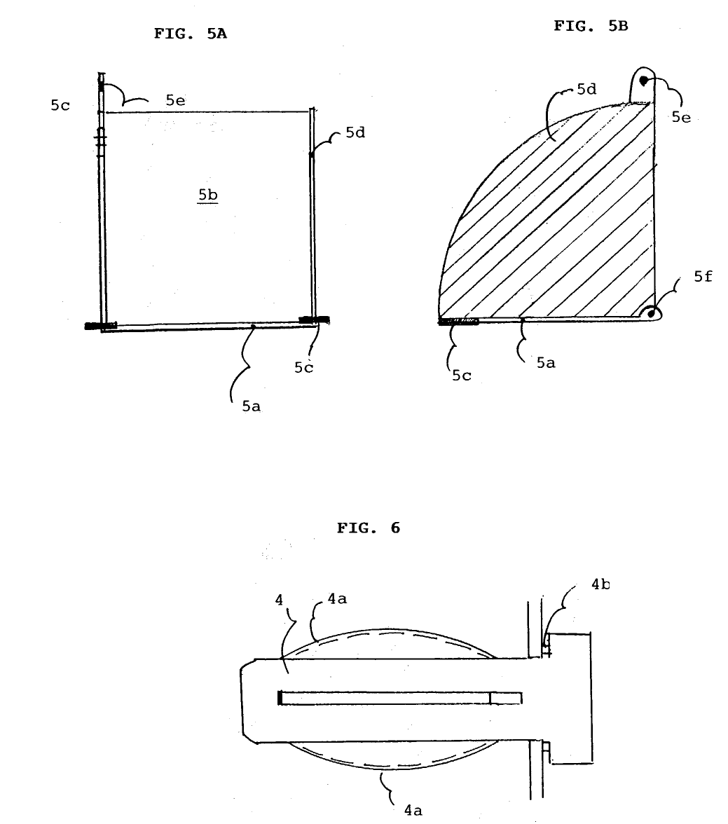

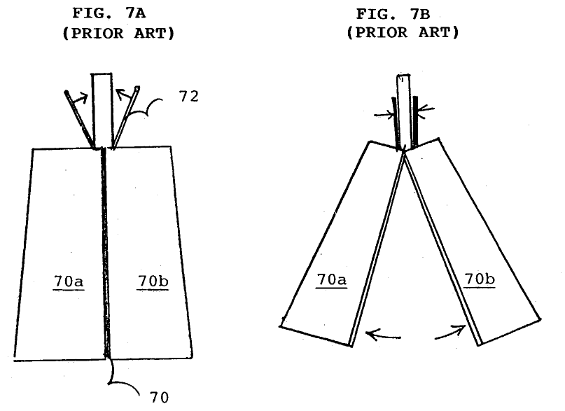

In FIG. 6, a further detail of the toilet paper core 4 is shown in which an arch-shaped steel spring plate 4a is provided with an expansion width of about 3 mm on each side of the toilet paper core 4. The spring plate allows for enabling compatibility with different hole diameters of commercially available toilet paper rolls. The core 4 may be provided to turn on bearings 4 for ease of drawing out the paper. The core holder part 4, provided with an inserted stopper mechanism, is turned by advancing the paper by rotating the knob 6 in one direction in order to extend paper only to a desired length. The window 3a in the side door 3 to the toilet paper containment chamber 2 enables visual confirmation of the remaining amount of the paper.

A handle device 7 is provided for the main unit housing, which can be made movable to the left or the right side so that the device can be adjusted in a fixed, upright manner. The binder or clip device 8 is provided on the outer side of the front wall 5a of the scoop for holding the leading edge of the toilet paper ready for the next usage. Plastic material may be used for fabrication of the main unit as well as for the various parts in the design construction to create a light-weight design.

The operation of the invention will be described next. When dogs are about to defecate, without exception, dogs will assume a defecating position for a few seconds. The opening and closing type of scoop 5 can therefore be opened on this occasion, or the scoop part can be opened first then placed directly under the anus of the dog when needed, making it possible to receive the feces directly onto the toilet paper then moved into the containment chamber 1. Since the angle of the opening of the scoop can be regulated, the device is thus compatible with dogs ranging from a small size to large dogs. Specifically, the greater the angle of opening of the scoop, the wider the opening part that will be created in the containment chamber. In addition, if one part of the main unit or the like is soiled by the feces, the attached feces can be wiped off by using the toilet paper provided in the device. With the feces wrapped in toilet paper and carried inside the unit, the dog owner may carry the feces back home and dispose of it in the toilet where it may be flushed into the processed waste stream.

With this invention, feces of dogs to be disposed of as waste can be collected without contaminating hands or clothing and can be discarded and processed by flushing them down the toilet. The invention thus enables simple, collection and processing of the feces of dogs, which currently tend to be discarded in public places by those not having a hygienic way of handling it. Since it can be expected that dealing with dog feces can thus be improved, the effect is that pollution of public spaces with dog feces can be eliminated, enabling dog owners to comply with societal requirements for optimal environmental hygiene.

It is to be understood that many modifications and variations may be devised given the above description of the principles of the invention. It is intended that all such modifications and variations be considered as within the spirit and scope of this invention, as defined in the following claims.

1. A dog feces collecting device comprising:
(a) a main unit having a collection chamber for receiving feces collected from a dog and a toilet paper holding chamber for holding a roll of toilet paper therein,
(b) a scoop provided on a front part of the collection chamber which is pivotable between a closed position in which it closes off the front part of the collection chamber and an open position in which it projects outwardly from the front part of the collection chamber as a feces receiving surface for the device,
wherein the toilet paper held in the toilet paper holding chamber is advanced from the toilet paper holding chamber around and onto the feces receiving surface of the scoop in the open position, so that the feces of the dog may be deposited on the toilet paper and wrapped therein and held in the collection chamber when the scoop is pivoted to the closed position for disposal in a hygienic manner.

2. A dog feces collecting device according to claim 1, wherein said scoop is formed with a front wall at a ninety degree angle to a back wall and is pivotable from 0 degree angle (closed position) to a ninety degree angle (open position) in which the front wall is pivoted to a horizontal position from the front part of the collection chamber and the back wall is pivoted to covering the front part of the collection chamber.

3. A dog feces collecting device according to claim 1, wherein said scoop is provided with side walls extending from the front wall to the back wall for preventing waste matter from dropping off the sides.

4. A dog feces collecting device according to claim 1, wherein said scoop is provided with a knob on one or both sides of the front wall projecting from the sides of the main unit for opening and closing the scoop.

5. A dog feces collecting device according to claim 1, wherein said toilet paper holding chamber is provided with a core holder for holding a roll of toilet paper thereon.

6. A dog feces collecting device according to claim 5, wherein said toilet paper core holder is provided with a spring plate for adjustably, holding different diameter cores of toilet paper rolls.

7. A dog feces collecting device according to claim 1, wherein said toilet paper holding chamber is provided with a paper advancing mechanism including a knob and paper feed roller for advancing a leading edge of the toilet paper out through a slot in the toilet paper holding chamber and onto the feces receiving surface of the scoop in the open position.

8. A dog feces collecting device according to claim 7, wherein said toilet paper advancing mechanism includes the operating knob being arranged for paper feeding by rotation in one direction.

9. A dog feces collecting device according to claim 7, wherein said toilet paper advancing mechanism advances the leading edge of the toilet paper through a slot in the bottom of the toilet paper holding chamber and along a paper path running along the bottom of the main unit to the scoop at the front part of the collection chamber.

10. A dog feces collecting device according to claim 9, wherein said scoop has a binder clip provided on a front surface thereof for holding the leading edge of the toilet paper thereto for the next usage thereof.

11. A dog feces collecting device according to claim 1, wherein said toilet paper holding chamber has a side access door for allowing access therein to install or change the roll of toilet paper.

12. A dog feces collecting device according to claim 1, wherein said toilet paper access door is provided with a transparent window for enabling the user to confirm the remaining amount of toilet paper in the device.

13. A dog feces collecting device according to claim 1, wherein said main unit is provided with a handle on an upper part thereof which can be moved to the left or to the right to adjust the upright position of the device during use.

14. A dog feces collecting device according to claim 1, wherein said main unit is made primarily of plastic material for a light weight design, and said scoop is made of metal for durability.
